(19) United States
(12) Patent Application Publication
(10) Pub. No.: US 2024/0407376 A1
(43) Pub. Date: Dec. 12, 2024

(54) SYSTEM AND METHOD FOR FORMING A DESSERT PRODUCT

(71) Applicant: Muddy Bites, Inc., Wilmington, DE (US)

(72) Inventor: Tyler DeVos, Denver, CO (US)

(21) Appl. No.: 18/696,847

(22) PCT Filed: Sep. 28, 2022
(86) PCT No.: PCT/US2022/045091

§ 371 Date: Mar. 28, 2024

Related U.S. Application Data
(60) Provisional application No. 63/249,067, filed on Sep. 28, 2021.

(51) Int. Cl. A21C 15/02; A21C 15/00; A21C 15/04

(52) U.S. Cl. CPC A21C 15/025; A21C 15/007; A21C 15/04

(57) ABSTRACT

Various aspects of this disclosure relate to a method of trimming a cone-shaped wafer, wherein the trimming is performed with an ultrasonic knife. The cone-shaped wafer may be an ice cream cone such as a waffle cone. In some specific embodiments, the cone-shaped wafer is trimmed to a length of no greater than 117 millimeters.

### CROSS-REFERENCE TO RELATED APPLICATION

The present application is an International Patent application claiming priority to and the benefit of U.S. Provisional Patent Application No. 63/249,067, filed 28 Sep. 2021, the disclosure of which is hereby incorporated, in its entirety, by this reference.

### BACKGROUND

Food production lines permit food products at larger scales with reduced cost. Automated production of some food products is nevertheless challenging.

Food products that are particularly challenging to produce include waffle cone dessert products because waffle cones have a fragile three-dimensional shape. Waffle cones are generally produced by hand at retail locations by forming waffles and rolling the waffles into the shape of cones prior to cooling while the waffles are still flexible.

Waffle cones typically have non-uniform open ends that pose production limitations. Non-uniform open ends can be broken or otherwise damaged during manufacturing, packaging, shipping, and storage, which damage is less appealing to consumers. Non-uniform shapes also present filling limitations, for example, because different cones have different maximum fill volumes and because accounting for variability inevitably results in one or both of underfilled and overfilled cones, which can result in production issues or less appealing products.

Improved methods of manufacturing cone-based food products remains desirable.

### SUMMARY

Various aspects of this disclosure relate to a method of trimming a cone-shaped wafer.

In some embodiments the method comprises providing an edible wafer that has a three-dimensional shape of a cone. In some specific embodiments, the edible wafer is an ice cream cone. In some very specific embodiments, the edible wafer is a waffle cone.

The term “comprising” refers to an open set, for example, such that a method that comprises providing an edible wafer may also comprise dispensing a filling into the edible wafer.

The term “ice cream cone” includes any edible wafer of the type that is recognizable as an ice cream cone independent of the filling. A filling of an ice cream cone may comprise, for example, one or more of a cream other than ice cream, chocolate, and fruit and still be an “ice cream” cone within the context of this disclosure, or an ice cream cone may lack a filling.

In some embodiments, the cone has an initial length. The initial length of the cone is a result-effective variable, for example, because length correlates with risk of breakage in at least two different ways: (1) longer-length cones are more fragile because they have open ends with larger voids that lack robust three-dimensional stability relative to comparable shorter-length cones; and (2) shorter-length cones are more challenging to cut because they have greater three-dimensional stability relative to longer-length cones such that the force necessary to cut a shorter-length cone can result in breaking or crushing the shorter-length cone. The cutting of cones that have a length of no greater 117 millimeters is believed to be novel.

In some embodiments, the cone has an open end that has an initial diameter. In some specific embodiments, the cone has an open end that has an initial diameter and a pointed end. In some very specific embodiments, the cone has an open end that has an initial diameter and a pointed end, wherein the pointed end and the open end are on opposite ends of the cone.

In some embodiments, the open end is open because the cone comprises a void. In some specific embodiments, the open end is open because the cone comprises a void that is filled with gas such as air.

In some embodiments, the pointed end of the cone lacks a void.

In some embodiments, the method comprises trimming the open end of the cone. In some specific embodiments, the method comprises trimming the open end of the cone with an ultrasonic knife. In some very specific embodiments, the method comprises trimming the open end of the cone with an ultrasonic knife, wherein the trimming removes a portion of the edible wafer from the open end of the cone to produce a trimmed cone.

In some embodiments, the ultrasonic knife is operated at a frequency of at least 20 kilohertz and no greater than 100 kilohertz. In some specific embodiments, the ultrasonic knife is operated at a frequency of at least 20 kilohertz and no greater than 35 kilohertz. In some very specific embodiments, the ultrasonic knife is operated at a frequency of about 20 kilohertz, about 30 kilohertz, or about 35 kilohertz.

In some embodiments, the ultrasonic knife is operated at a sub-ultrasonic frequency. In some specific embodiments, the ultrasonic knife is operated at a sub-ultrasonic frequency of at least 300 hertz and less than 20 kilohertz. In some very specific embodiments, the ultrasonic knife is operated at a sub-ultrasonic frequency of at least 300 hertz and less than 20 kilohertz to create variation in the trimming.

In some embodiments, operating the ultrasonic knife comprises operating a sonic generator that powers the ultrasonic knife.

In some embodiments, the ultrasonic knife has a cutting blade that is metal or a metal alloy. In some specific embodiments, the ultrasonic knife has a cutting blade that comprises aluminum, titanium, or steel. In some very specific embodiments, the ultrasonic knife has a cutting blade that consists of aluminum alloy, titanium, or sintered steel.

In some embodiments, the cutting blade is configured according to a finite element model to cut food products.

Prior methods of cutting the open ends of ice cream cones were limited to the cutting of cones to lengths of greater than 117 millimeters, for example, using conventional blades. Blades that include knife blades, guillotine-type blades, and paired shear-type blades fail at cutting ice cream cones to lengths of no greater than 117 millimeters in length, for example, because they either shatter or crush the cones, and therefor do not result in uniform open ends. Ultrasonic knifes are capable of cutting ice cream cones to lengths of at least 38 millimeters and no greater than 117 millimeters, and ultrasonic knifes can be readily adapted to cut ice cream cones. Other methods capable of cutting ice cream cones to lengths of no greater than 117 millimeters include reciprocating saws and tube cutters.

In some embodiments, the trimming the performed with a reciprocating saw.

In some embodiments, the trimming the performed with a tube cutter.

In some embodiments, the trimmed cone has a trimmed length of no greater than 117 millimeters. In some specific embodiments, the trimmed cone has a trimmed length of at least 38 millimeters no greater than 117 millimeters. In some very specific embodiments, the trimmed cone has a trimmed length of at least 41 millimeters no greater than 117 millimeters.

In some embodiments, the edible wafer is an ice cream cone. In some specific embodiments, the edible wafer is a waffle cone.

In some embodiments, the edible wafer comprises a flour. In some specific embodiments, the edible wafer is made from ingredients that comprise a flour, water or milk, and optionally eggs. In some very specific embodiments, the edible wafer is made from waffle batter that includes ingredients that comprise comprises flour, water or milk, optionally eggs, and salt.

In some embodiments, the trimmed cone has a trimmed open end that has a trimmed diameter of no greater than 51 millimeters. In some specific embodiments, the trimmed cone has a trimmed open end that has a trimmed diameter of at least 16 millimeters and no greater than 51 millimeters.

In some embodiments, the edible wafer has a minimum thickness of no greater than 9 millimeters. In some specific embodiments, the edible wafer has a minimum thickness of at least 1 millimeter and no greater than 9 millimeters.

In some embodiments, the trimmed cone has a mass of no greater than 21 grams. In some specific embodiments, the trimmed cone has a mass of at least 2 grams and no greater than 21 grams. In some very specific embodiments, the trimmed cone has a mass of at least 2.5 grams and no greater than 6 grams.

In some embodiments, the trimmed cone has an angle of at least 14 degrees and no greater than 29 degrees.

In some embodiments, the trimmed cone has a tensile strength of no greater than 40 newtons. In some specific embodiments, the trimmed cone has a tensile strength of at least 3 newtons and no greater than 40 newtons.

In some embodiments, the method comprises dispensing a filling into the trimmed cone to produce an edible product.

In some embodiments, the method comprises packaging the edible product in packaging. In some specific embodiments, the method comprises packaging the edible product in packaging, wherein the packaging comprises a nutrition label. In some very specific embodiments, the method comprises packaging the edible product in packaging, wherein the packaging comprises a nutrition label such that the edible product is suitable for retail sale.

In some embodiments, the method comprises providing a dispensing device that comprises a heat exchanger, wherein the dispensing is performed with the dispensing device.

In some embodiments, the heat exchanger is a jacketed heat exchanger such as a tube-in-shell heat exchanger. In some specific embodiments, the heat exchanger is configured to transfer heat from a heated fluid. In some very specific embodiments, the heat exchanger is configured to transfer heat from heated water.

In some embodiments, the method comprises heating the filling with the heat exchanger of the dispensing device.

In some embodiments, the method comprises cooling the edible product. In some specific embodiments, the method comprises passively cooling the edible product. In some very specific embodiments, the method comprises passively cooling the edible product such as by allowing the edible product to cool at ambient temperature such as room temperature. In some specific embodiments, the method comprises actively cooling the edible product. In some very specific embodiments, the method comprises actively cooling the edible product such as by refrigerating the edible product.

In some embodiments, the filing has a melting point. In some specific embodiments, the filing has a melting point, and the melting point of the filing is greater than 21 degrees Celsius.

In some embodiments, heating the filling comprises heating to a temperature that is greater than the melting point of the filling.

In some embodiments, cooling the edible product comprises cooling to a temperature below the melting point of the filling.

In some embodiments, the filling is a solid at 21 degrees Celsius.

Various aspects of this disclosure relate to a trimmed cone-shaped wafer prepared according to a method as described anywhere in this disclosure including, for example, edible products that comprise such a trimmed cone-shaped wafer and consumer packaged goods that comprise such edible products. In some embodiments, the trimmed cone-shaped wafer has a trimmed length of at least 38 millimeters no greater than 117 millimeters. In some specific embodiments, the trimmed cone-shaped wafer is a waffle cone that has a trimmed length of at least 38 millimeters no greater than 117 millimeters. In some very specific embodiments, the trimmed cone-shaped wafer is a waffle cone that has a trimmed length of at least 38 millimeters no greater than 117 millimeters, which trimmed length was trimmed using an ultrasonic knife.

### BRIEF DESCRIPTION OF THE DRAWINGS

FIG. 1 is a drawing that depicts trimming of edible wafers to produce trimmed cone-shaped wafers on a production line.

FIG. 2 is a drawing that depicts an edible product that comprises a trimmed cone-shaped wafer that is filled with a filling.

FIG. 3 is a flowchart that depicts a process to manufacture an edible product as described in FIG. 2.

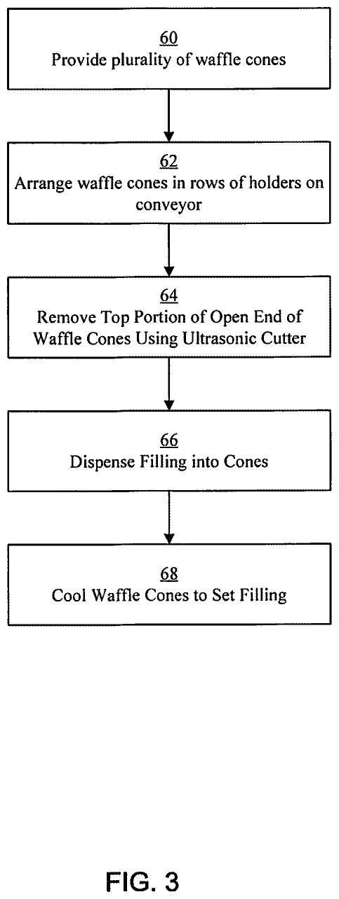

FIG. 4 is a flowchart that depicts various steps to make waffle cones, one or more of which may optionally be part of a method to provide an edible wafer.

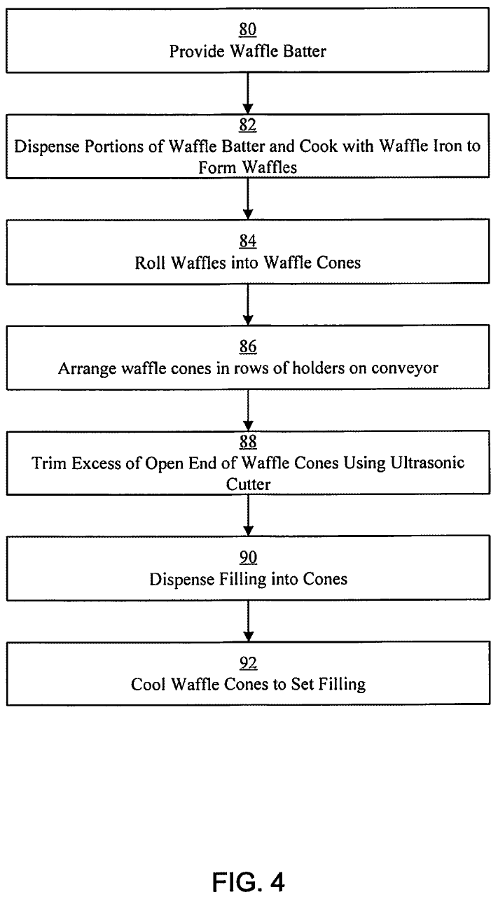

FIG. 5 is a drawing that depicts filling of trimmed cone-shaped wafers on a production line.

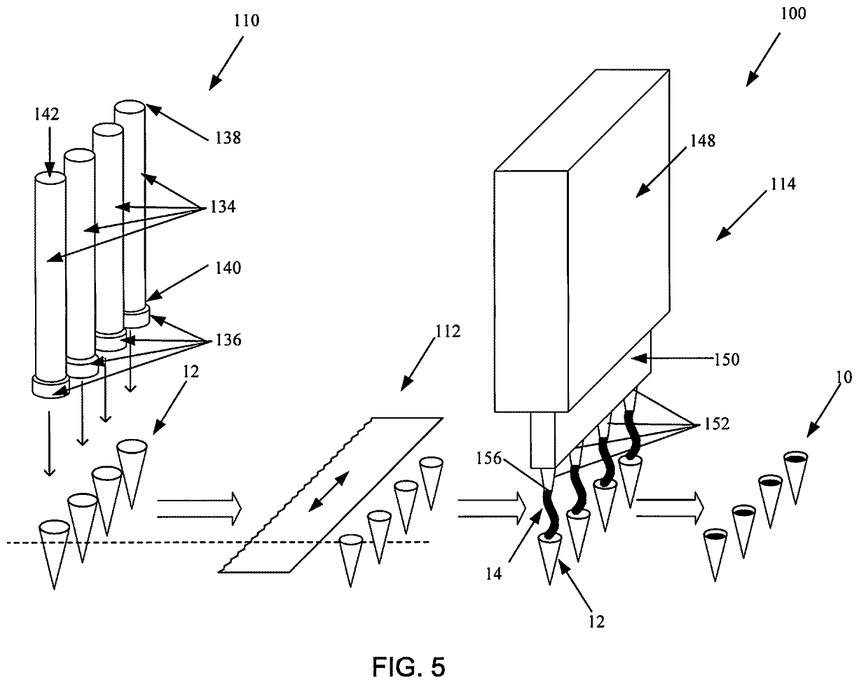

FIG. 6 is a drawing of a conveyor of a production line.

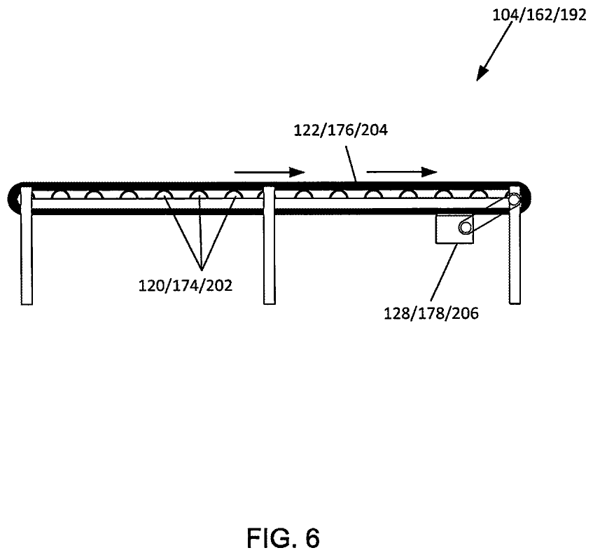

FIG. 7 is a drawing that depicts rolling of waffle cones on a production line, which may optionally be part of a method to provide an edible wafer.

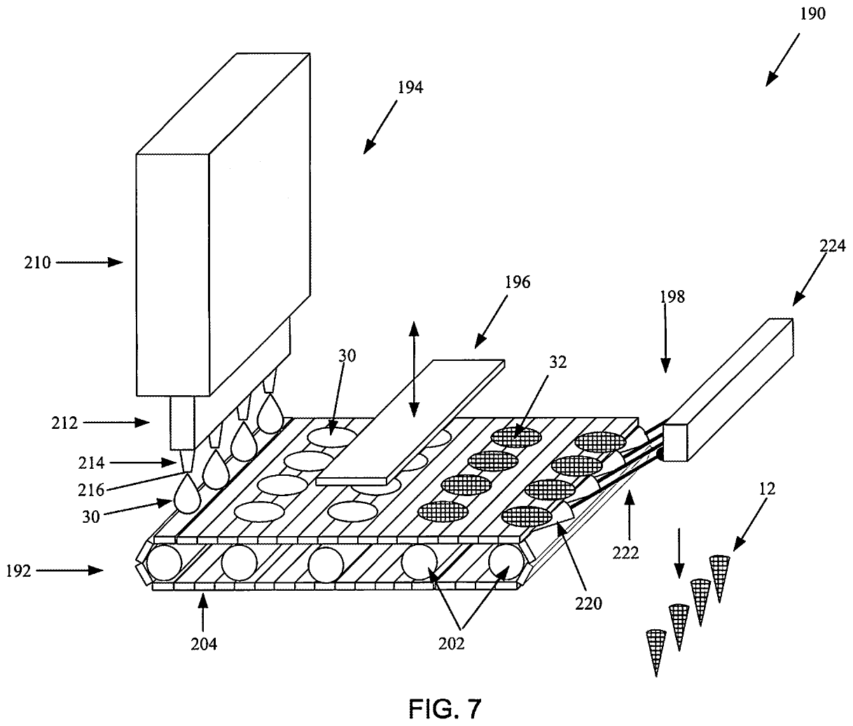

FIG. 8 is a drawing that depicts a side view of a production line.

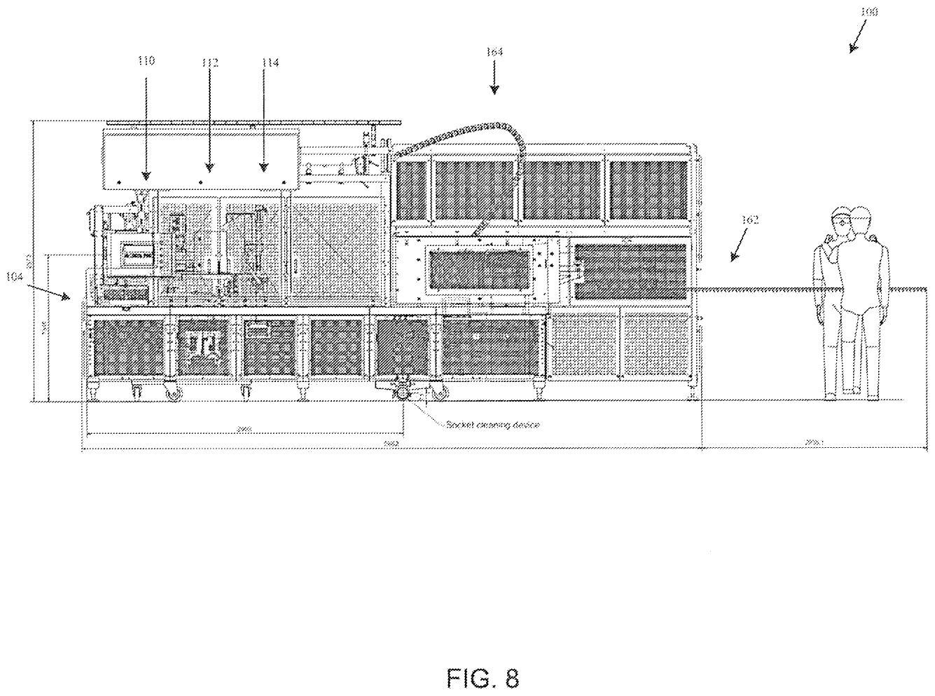

FIG. 9 is a drawing that depicts a top view of a production line.

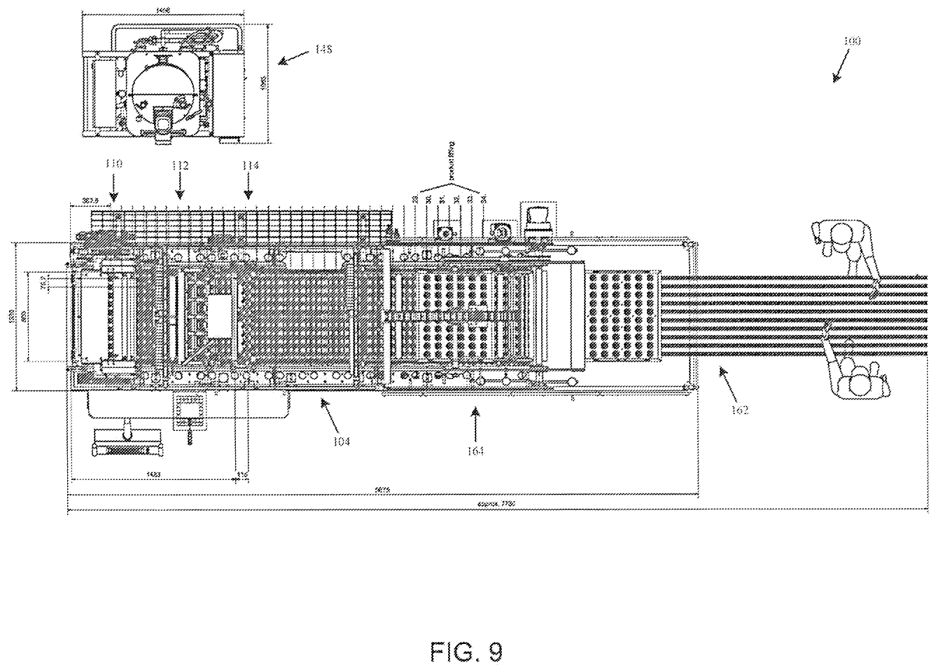

FIG. 10 is a drawing that depicts an end view of a production line.

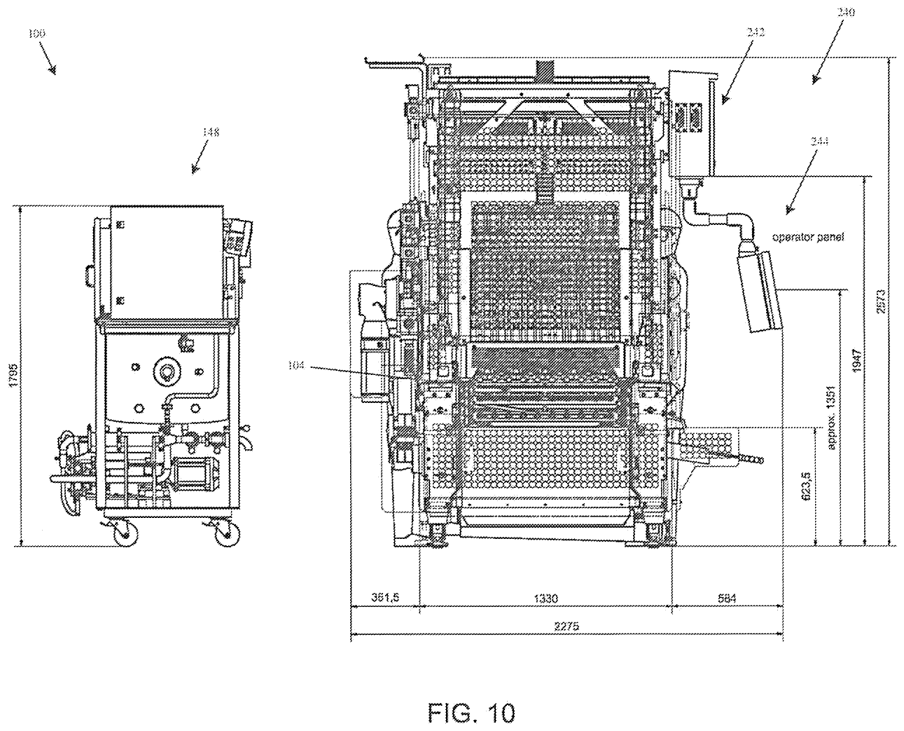

FIG. 11 is a diagram of a control system to operate a production line.

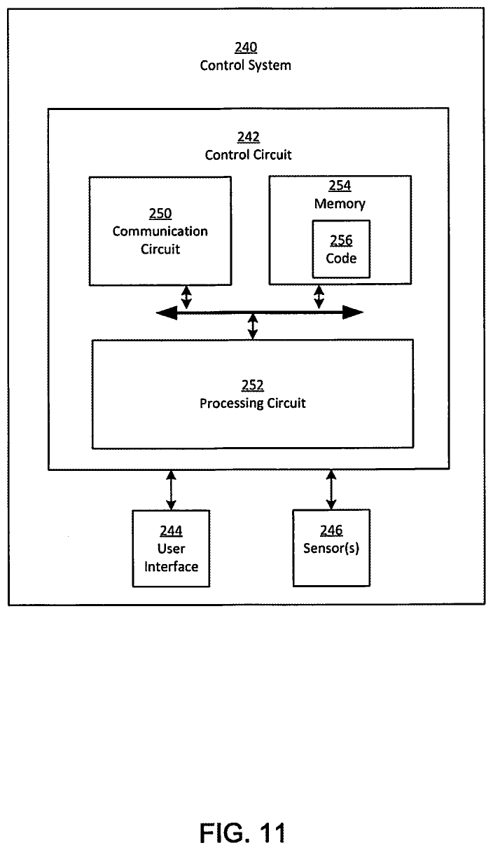

### DETAILED DESCRIPTION

Various aspects of the disclosure relate to methods for formation of a dessert product having waffle cones with a filling. Various aspects of the disclosure relate to systems for formation of a dessert product having waffle cones with a filling.

In some embodiments, a method for formation of a dessert product is suitable for implementation on a production line.

In some embodiments, a method for formation of a dessert product that is durable.

In some embodiments, a method for formation of a dessert product that has a robust design.

In some embodiments, a method for formation of a dessert product that is high quality.

The preceding and other features and advantages of the disclosure will become apparent from this disclosure, the figures, and the claims that follow.

In some embodiments, a plurality of waffle cones are provided.

In some embodiments, each waffle cone of the plurality of waffle cones has an open end and a pointed end.

In some embodiments, each waffle cone is placed into a row of holders on a conveyor.

In some embodiments, a top portion of each open end is trimmed to produce a plurality of trimmed waffle cones.

In some embodiments, a filling is dispensed into each of the trimmed waffle cones to produce a plurality of filled waffle cones.

In some embodiments, the plurality of filled waffle cones are cooled to cause the filling to set.

Various aspects of this disclosure relate to a system for forming a dessert product.

In some embodiments, the system includes a waffle cone dispenser, a cutting apparatus, and a filling injector among other components.

In some embodiments, the waffle cone dispenser is configured to provide and place a plurality of waffle cones into a row of holders on a conveyor.

In some embodiments, the cutting apparatus is configured to cut off a top portion of the open end of the plurality of waffle cones to produce a plurality of trimmed waffle cones.

In some embodiments, the cutting apparatus is an ultrasonic knife.

In some embodiments, the filling injector is configured to dispense filling into the plurality of trimmed waffle cones to produce a plurality of filled waffle cones.

The drawings form a part of this disclosure and depict specific embodiments in which the disclosure may be practiced. The embodiments of the present disclosure are not intended to be exhaustive or to limit the disclosure to the precise forms in the description. Rather, the embodiments are chosen and described so that others skilled in the art may appreciate and understand the principles and practices of the present disclosure. It will be understood by those skilled in the art that various changes in form and details may be made without departing from the principles and scope of the invention. The disclosure is intended to cover various modifications and similar arrangements and procedures, and the scope of the appended claims should be accorded the broadest interpretation to encompass all such modifications and similar arrangements and procedures. For instance, although aspects and features may be illustrated in or described with reference to certain figures or embodiments, features from one figure or embodiment may be combined with features of another figure or embodiment even though the combination is not necessarily explicitly shown or described as a combination. In the depicted embodiments, like reference numbers refer to like elements throughout the various drawings.

The contemplated embodiments are not limited by their advantages and shall not be interpreted as being restricted to embodiments which provide such advantages or improvements. Similarly, various embodiments may address less than all objects of the disclosure or invention as described herein. The contemplated embodiments shall not be interpreted as being restricted to embodiments that address such objects of the disclosure and invention. Furthermore, although some disclosed embodiments may be described relative to specific materials or methods, the embodiments are not limited to the specific materials or methods, but only to their specific characteristics and capabilities; other materials and methods can be substituted as is understood by those skilled in the art in view of the present disclosure.

With reference to the figures, a new method for production of a dessert product is presented. In one or more arrangements, the method is configured for production of a dessert product having waffle cones filled with a filling. As previously described, waffle cones have a non-uniform shaped open end that poses several challenges in the production of the dessert product. In one or more arrangements, the non-uniform shaped open end of waffle cones are removed to facilitate production of a dessert product. Removal of the non-uniform portion facilitates automated processing of the waffle cones to produce a dessert product having the desired filling: cone ratio and while retaining the characteristics of waffle cones. Furthermore, although removal of the non-uniform shaped open end of waffle cones creates cone byproduct, it has been surprisingly discovered, that removal of the non-uniform portion may actually reduce the amount of byproduct generate by reducing loses in comparison to processing of untrimmed cones, which may be damaged when the non-uniform portion is manipulated during processing.

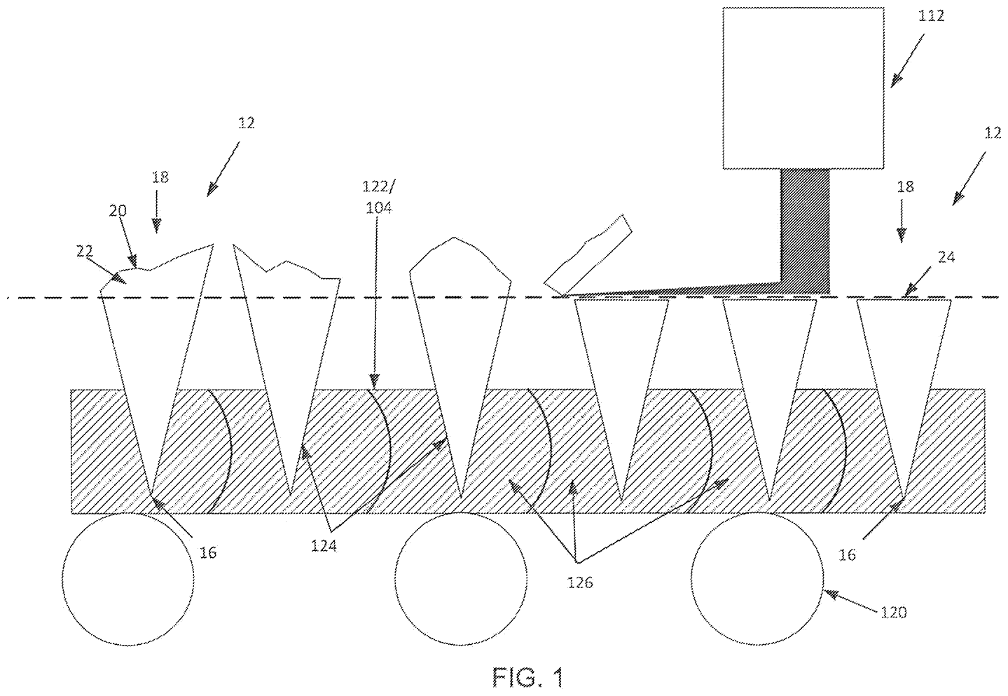

FIG. 1 shows a flowchart of an example process for producing a dessert product 10 having a waffle cone 12 filled with a filling 14, in accordance with one or more embodiments of the present disclosure. In this example arrangement, a plurality of waffle cones 12 are provided at process block 60. In one or more arrangements, the waffle cones have a pointed end 16 and an open end 18 having a non-uniform upper edge 20. At process block 62, the waffle cones 12 are arranged in one or more rows of holders 124 on a conveyor 104. At process block 64, a upper portion 22 of the open end 18 of the waffle cones 12 are removed (e.g., using an ultra-sonic cutter). The remaining portion of waffle cones 12 have a uniform upper edge 24. At process block 66, filling 14 is dispensed into waffle cones 12. At process block 68, the waffle cones are cooled to set the filling 14.

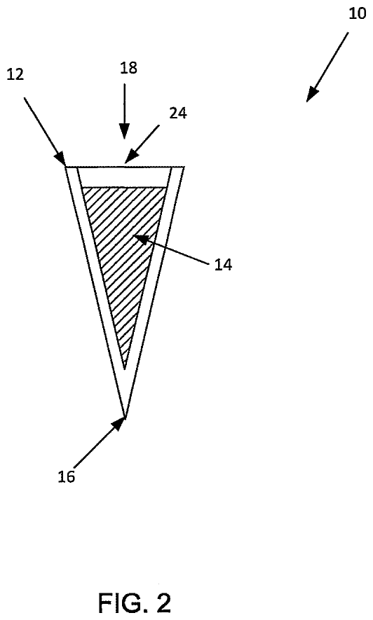

FIG. 2 shows a flowchart of another example process for producing a dessert product 10 having a waffle cone 12 filled with a filling 14, in accordance with one or more embodiments of the present disclosure. In this example arrangement, a plurality of waffle cones 12 are produced at process blocks 80-84. At process block 80, a batch of waffle batter 30 is provided. In some various arrangements, the waffle batter 30 may be provided by measuring and mixing ingredients in a mixer. However, the embodiments are not so limited. Rather, it is contemplated that in one or more arrangements the batch waffle batter 30 may be premixed batter. At process block 82, portions of the waffle batter 30 are dispensed and cooked using a waffle iron 196 to form waffles 32. At process block 84, waffles 32 are rolled to form waffle cones 12. In one or more arrangements, the waffle cones 12 have a pointed end 16 and an open end 18 having a non-uniform upper edge 20.

At process block 86, the waffle cones 12 are arranged in one or more rows of holders 124 on conveyor 104. At process block 88, upper portion 22 of the open end 18 of the waffle cones 12 are removed (e.g., using an ultra-sonic cutter). The remaining portion of waffle cones 12 have a uniform upper edge 24. At process block 90, filling 14 is dispensed into waffle cones 12. At process block 68, the waffle cones 12 are cooled to set the filling 14.

### System 100:

In one or more arrangements, a system for producing a dessert product having waffle cones 12 filled with a filling 14 is presented (system 100). In one or more arrangements, system 100 includes a conveyor 104 having a plurality of holders 124, a cone dispenser 110, a cutting apparatus 112, and a filling dispenser 114 among other components.

### Conveyor 104:

Conveyor 104 is formed of any suitable size, shape, and design and is configured to transport waffle cones 12 between cone dispenser 110, cutting apparatus 112, filling dispenser 114, and/or other components of system 100 for processing to facilitate production of finished dessert products 10. In the arrangement shown, as one example, conveyor 104 is a modular belt-type conveyor having a rollers 120, a belt 122 formed of interconnected segments 126 and positioned on rollers 120, and a motor 128. However, the arrangements are not so limited. Rather, it is contemplated that in some various embodiments conveyor 104 may be various different types of conveyors including but not limited to, for example, flat belt conveyors, modular belt conveyors, cleated belt conveyors, nub top belt conveyors, sandwich type conveyors, and/or any other type of conveyor.

In the arrangement shown, as one example, segments 126 of belt 122 each have a row of holders 124. Holders 124 are formed of any suitable size, shape, and design and are configured to hold waffle cones 12. In the arrangement shown, as one example, holders 124 have an inverted conical shape configured to receive pointed end 16 of waffle cones 12 and hold waffle cones 12 with open end 18 facing upward.

During operation, motor 128 causes belt 122 to be rotated around rollers 120 in a loop to facilitate transport of waffle cones 12 in holder 124 on a top side of belt 122. Motor 128 is formed of any suitable size, shape, and design and is configured to generate mechanical movement. In the arrangement shown, as one example, motor 128 is an electric motor (e.g., a DC motor or an AC motor) configured to convert electric power into rotational motion. However, embodiments are not so limited. For example, in some arrangements, motor 128 may be an internal combustion engine, a fluid driven engine (e.g., steam, water, and/or air driven), or any other type of motor or engine.

### Cone Dispenser 110:

Cone dispenser 110 is formed of any suitable size, shape, and design and is configured to place waffle cones 12 into empty holders 124 of segments 126 of belt 122 as belt 122 is rotated during production. In the arrangement shown, as one example, cone dispenser 110 includes a plurality of tube feeders 134 and meter assemblies 136. In this example arrangement, cone dispenser 110 includes a respective tube feeder for each holder 124 of a segment 126.

### Tube Feeders 134:

Tube feeders 134 are formed of any suitable size, shape, and design and are configured to receive and hold a plurality of waffle cones 12 for dispensing by meter assemblies 136 during operation. In the arrangement shown, tube feeders 134 have an elongated cylindrical tube shape extending from an upper end 138 to a lower end 140. In this example arrangement, tube feeders have a hollow interior 142 of an inner diameter of sufficient size to accommodate holding a stack of waffle cones 12 therein without breaking or otherwise damaging the waffle cones 12.

### Meter Assemblies 136:

Meter assemblies 136 are formed of any suitable size, shape, and design and are configured to dispense a single waffle cone 12 from lower end 140 a tube feeder 134 into an empty holder 124 of belt 122 of conveyor 104 positioned below meter assembly 136. In an example arrangement, meter assemblies 136 may include one or more actuated collars (not shown) operably connected to the lower end 140 of tube feeders 134. For instance, such actuated collars may be configured to expand (e.g., in response to a control signal) to permit gravity to move a bottom most waffle cone 12 in tube feeder 134 to pass out through lower end 140 of tube feeder 134. However, the embodiments are not so limited. Rather, it is contemplated that in some various arrangements, meter assemblies 136 may user various means and/or methods to meter waffle cones 12 from tube feeders 134 including but not limited to collars, wheels, augers, levers, latches, grips, claws, paddles, pressurized air, suction, and/or any other means or method for metering items.

### Cutting Apparatus 112:

In one or more arrangements, conveyor 104 is configured to transport waffle cones 12 dispensed by cone dispenser 110 into a row of holders 124 in a segment 126 of belt 122 past cutting apparatus 112. Cutting apparatus 112 is formed of any suitable size, shape, and design and is configured to remove upper portion 22 of waffle cone 12 to form a uniform edge 24 as waffle cones are transported past cutting apparatus.

In the arrangement shown, as one example, cutting apparatus 112 is a reciprocating cutting blade, saw, and/or other cutting tool configured to cut of the upper portion 22 from waffle cones 12. In one or more arrangements, cutting apparatus 112 is an ultra-sonic cutting device configured to vibrate blade, saw, and/or other cutting tool at a high frequency (e.g., 20+kHz) to facilitate cutting of waffle cones 12 in a manner that produces a clean uniform edge 24.

However, the embodiments are not so limited. Rather, it is contemplated that in some various arrangements cutting apparatus 112 may utilize various different methods and/or means for cutting including but not limited to, for example, reciprocating cutters, band cutters, rotary cutters, chop saws, lathes, grinders, ultra-sonic cutters, laser cutters, heating elements, water jets, air jets, and/or any other method and/or means for cutting.

### Filling Dispenser 114:

In one or more arrangements, conveyor 104 is configured to transport trimmed waffle cones 12 having a uniform edge 24 from cutting apparatus 112 to filling dispenser 114. Filling dispenser 114 is formed of any suitable size, shape, and design and is configured to dispense filling 14 into waffle cones 12. In the arrangement shown, as one example, filling dispenser 114 includes a container 148, a dispense mechanism 150, and a set of nozzles 152.

### Container 148:

Container 148 is formed of any suitable size, shape, and design and is configured to hold prepared filling 14 for dispensing by filling dispenser 114. In one or more arrangements, container 148 is formed of a food safe material and is configured to be easily refiled with new batches of filling 14 as required to maintain operation of system 100. In some arrangements container 148 may be additionally or alternatively configured to mix and/or process ingredients to prepare the filling 14 before it is dispensed by filling dispenser 114.

### Dispense Mechanism 150:

Dispense mechanism 150 is formed of any suitable size, shape, and design and is configured to move prepared filling 14 from container 148 through nozzles 152 to dispense filling 14 into waffle cones 12 positioned below nozzles 152. In some various different arrangements, dispense mechanism 150 may use various different means or methods to move prepared filling 14 from container 148 through nozzles 152 including but not limited to, pistons, augers, pumps, valves, and/or any other method or means for moving filling 14.

### Nozzles 152:

Nozzles 152 is formed of any suitable size, shape, and design and is configured to direct filling 14 from dispense mechanism 150 into waffle cones 12 through open end 18. In the arrangement shown, as one example, nozzles 152 are simple funnel shaped nozzles having a round shaped opening 156. However, the embodiments are not so limited. Rather, it is contemplated that in some various different arrangements filling dispenser 114 may utilize various different types of nozzles including but not limited to, for example, round nozzles, multi-hole nozzles, basket nozzles, petal nozzles, closed star nozzles, open star nozzles, flower nozzles, leaf nozzles, needle and/or injector shaped nozzles, and/or any other type of nozzle.

It is understood that in some various different arrangements, filling dispenser 114 may deposit various types of fillings 14 into waffle cones 12 including but not limited to, for example, custards, puddings, whipped creams, chocolates, fudges, marshmallow, ganache, nuggets, frostings, buttercreams and/or other creams, non-dairy creames, meringues, ice-creams, gelatos, flans, caramels, toffees, nuts, seeds, butters, fruits, jellies, jams, syrups, cheeses, dulce de leche, liquors, candies, and/or any other type of edible filling.

### Output Section 160:

In one or more arrangements, system 100 includes an output section to facilitate cooling of dessert 10 after filling 14 is dispensed into waffles cones 12 to permit filling 14 to set, to consolidate prepared desserts before packaging, and/or to facilitate inspection of prepared desserts 10. In the arrangement shown, as one example, output section 160 includes a second conveyor 162, onto which desserts 10 are placed (e.g., for cooling and/or inspection) and a transporter 164.

### Conveyor 162:

Conveyor 162 is formed of any suitable size, shape, and design and is configured to receive and hold produced desserts 10 at a source end of conveyor 162 and transport the dessert products to a destination end of conveyor 162. Conveyor 162 is generally similar to conveyor 104 in structure and operation with the primary difference relating to the type of belt used by conveyor 162. In the arrangement shown, as one example, conveyor 162 is a belt-type conveyor having rollers 174, a belt 176 positioned on rollers 174, and a motor 178, which are arranged and operate similar to rollers 120, belt 122, and motor 128 of conveyor 104. In this example arrangement, belt 176 has channels 180 extending the length of conveyor 162. In this example arrangement, channels 180 are formed by walls 182 that extend out from a top surface of belt 176. In this example arrangement, walls 182 are formed by a flexible food safe material (e.g. food safe silicone) to facilitate secure holding of desserts 10 without damaging waffle cones 12.

### Transporter 164:

Transporter 164 is formed of any suitable size, shape, and design and is configured to transport finished desserts 10 from conveyor 104, after waffle cones 12 are filled with filling 14 by filling dispenser 114, to conveyor 162 of output section 160. In the arrangement shown, as one example, transporter 164 is a pick-and-place type transporter configured to pick up desserts 10 from conveyor 104 and place the desserts 10 into channels 180 of belt 176 on conveyor 162.

In this example arrangement, transporter 164 is configured to pick up and transport desserts 10 from holders 124 of multiple row segments 126 of belt 122 of conveyor 104 at the same time. In one or more arrangements, transporter 164 and conveyor 162 are configured to place desserts 10 on conveyor 162 so rows of the desserts 10 are interleaved with rows of the desserts 10 previously placed on conveyor 162 to cause desserts 10 be positioned closer together than on conveyor 104.

### Cooling/Setting of Filling Not Required:

While some arrangements may be primarily described with reference to cooling of desserts 10 after filling 14 is deposited into waffle cones 12 to allow filling 14 to set, the embodiments are not so limited. Rather, it is understood that in some various arrangements, filling 14 may be configured to set by means other than cooling. For example, in one or more arrangements, desserts may be baked after filling 14 is deposited in waffle cones 12 to cause filling 14 to set. Furthermore, it is understood that in some various arrangements, filling 14 may not require setting after it is deposited into cones.

### Waffle Cone Maker 190:

In one or more arrangements, system 100 includes a waffle cone maker 190 configured to prepare waffle cones 12 for use by cone dispenser 110. Waffle cone maker 190 is formed of any suitable size, shape, and design, and is configured to produce waffle cones 12 for use by cone dispenser 110. In the arrangement shown, as one example, waffle cone maker 190 includes a conveyor 192, a batter dispenser 194, a waffle iron 196, and a cone roller 198, among other components.

### Conveyor 192:

Conveyor 192 is formed of any suitable size, shape, and design and is configured to operate as a moving cooking surface for cooking and transportation of waffles 32. Conveyor 192 is generally similar to conveyors 104 and 162 in structure and operation with the primary difference relating to the type of belt used by conveyor 192. In the arrangement shown, as one example, conveyor 192 is a modular belt-type conveyor having rollers 202, a belt 204 configured for use as a cooking surface for making waffles and positioned on rollers 202, and a motor 206, which are arranged and operate similar to rollers 120, belt 122, and motor 128 of conveyor 104.

In this example arrangement, belt 204 is configured to transport portions of waffle batter 30 from a source end of conveyor 192, where the waffle batter 30 is deposited by batter dispenser 194, to waffle iron 196 for cooking the batter into waffles 32, and then to a destination end of conveyor 192 where waffles are provided to cone roller 198 for shaping into waffle cones 12.

### Batter Dispenser 194:

Batter dispenser 194 is formed of any suitable size, shape, and design and is configured to dispense uniform portions of waffle batter 30 for making into waffles 32. In the arrangement shown, as one example, batter dispenser 194 includes a container 210, a dispense mechanism 212, and a set of nozzles 214.

### Container 210:

Container 210 is formed of any suitable size, shape, and design and is configured to hold prepared waffle batter 30 for dispensing by batter dispenser 194. In one or more arrangements, container 210 is formed of a food safe material and is configured to be easily refiled with new batches of waffle batter 30 as required to maintain operation of system 100. In some arrangements, container 210 may be additionally or alternatively configured to mix and/or process ingredients to prepare the waffle batter 30 before it is dispensed by batter dispenser 194.

### Dispense Mechanism 212:

Dispense mechanism 212 is formed of any suitable size, shape, and design and is configured to meter prepared waffle batter 30 from container 210 through nozzles 214 and onto belt 204 of conveyor 192 for making of waffles 32. Alternatively, in some arrangements, batter dispenser 194 may be configured to dispense waffle batter 30 directly to a waffle iron 196. In some various different arrangements, dispense mechanism 212 may use various different means or methods to meter out prepared waffle batter 30 from container 210 through nozzles 214 including but not limited to, pistons, augers, pumps, valves, and/or any other method or means for moving waffle batter 30.

### Nozzles 214:

Nozzles 214 is formed of any suitable size, shape, and design and is configured to direct waffle batter 30 from dispense mechanism 212 onto belt 204 of conveyor 192 of other cooking surface (e.g., waffle iron 196). In the arrangement shown, nozzles 214 are simple funnel shaped nozzles having a round shaped opening 216. However, the embodiments are not so limited. Rather, it is contemplated that in some various different arrangements filling dispenser 114 may any type of nozzle.

### Waffle Iron 196:

Waffle iron 196 is formed of any suitable size, shape, and design and is configured to cook metered portions of waffle batter 30 to form waffles 32. In the arrangement shown, as one example, waffle iron 196 is configured to press and cook portions of waffle batter 30 on belt 204 of conveyor 192. However, the embodiments are not so limited. Rather, it is contemplated that in various different embodiments, waffle cone maker 190 may be configured to use any type of waffle maker.

### Cone Roller 198:

Cone roller 198 is formed of any suitable size, shape, and design and is configured to shape cooked waffles 32 into a cone shape to form waffle cones 12. In the arrangement shown, as one example, cone roller includes cone shaped armatures 220, shafts 222, an actuator assembly 224 among other components. Shafts 222 are configured to operably connect cone shaped armatures 220 with actuator assembly 224. In this example arrangement, actuator assembly 224 is operably connected to shafts 222 and are configured to pivot shafts 222 to move cone shaped armatures 220 between an upper position, proximate to conveyor 192 to facilitate rolling of waffles 32, and a lower position, to facilitate removal of shaped waffle cones 12. In this example arrangement, when cone shaped armatures 220 are in the upper position actuator assembly 224 is also configured to rotate shafts 222 and cone shaped armatures 220 to roll freshly made waffles 32 on cone shaped armatures 220 to shape waffles into cone shapes. When waffles 32 are sufficiently cooled to retain their shape, actuator assembly 224 pivot shafts 222 to move cone shaped armatures to the lower position to remove waffle cones 12 from cone shaped armatures 220 by gravity.

### Control System 240:

In one or more arrangements, system 100 includes a control system 240. Control system 240 is formed of any suitable size, shape, and design and is configured to control operation of conveyor 104, cone dispenser 110, cutting apparatus 112, filling dispenser 114, conveyor 162 and/or transporter 164 of output section 160, conveyor 192, batter dispenser 194, waffle iron 196, and/or cone roller 198 of waffle cone maker 190 and/or other components of system 100. In the arrangement shown, as one example, control system 240 includes a control circuit 242, user interface 244, and/or sensors 246, among other components of system 100.

### Control Circuit 242:

Control circuit 242 is formed of any suitable size, shape, design and is configured to control operation of various components of system 100 to facilitate production of desserts 10, as described herein, in response to signals of sensors 246 and/or input from user interface 244. In the arrangement shown, as one example, control circuit 242 includes a communication circuit 250, a processing circuit 252, and a memory 254 having software code 256 or instructions that facilitates the operation of system 100.

### Processing Circuit 252:

Processing circuit 252 may be any computing device that receives and processes information and outputs commands according to software code 256 stored in memory 254. For example, in some various arrangements, processing circuit 252 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 254.

### Memory 254:

Memory 254 may be any form of information storage such as flash memory, ram memory, dram memory, a hard drive, or any other form of memory Processing circuit 252 and memory 254 may be formed of a single combined unit. Alternatively, processing circuit 252 and memory 254 may be formed of separate but electrically connected components. Alternatively, processing circuit 252 and memory 254 may each be formed of multiple separate but communicatively connected components.

Software code 256 is any form of instructions or rules that direct processing circuit 252 how to receive, interpret and respond to information to operate as described herein. Software code 256 or instructions is stored in memory 254 and accessible to processing circuit 252. As an illustrative example, in one or more arrangements, software code 256 or instructions may configure processing circuit 252 control circuit 242 to monitor sensors 246 to facilitate control of various components of system 100 and/or communicate status alerts staff (e.g., via automated call, SMS, push notification, email, messaging on social networks, or any other means or methods for messaging). In one or more arrangements, operation of control circuit 242 is configurable by a user via user interface 244 to customize/adjust operation of system 100.

### Communication Circuit 250:

Communication circuit 250 is formed of any suitable size, shape, design, technology, and in any arrangement and is configured to facilitate communication with devices to be controlled, monitored, and/or alerted by control system 240. In one or more arrangements, as one example, communication circuit 250 includes a transmitter (for one-way communication) or transceiver (for two-way communication). In various arrangements, communication circuit 250 may be configured to communicate with various components of system 100 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Sensors 246:

Sensors 246 are formed of any suitable size, shape, design, technology, and in any arrangement configured to provide information relevant to operation of system 100. In some various arrangements, sensors 246 may include but are not limited to, for example, temperature sensors, chemical sensors, humidity sensors, positional sensors, weight sensors, timers, and/or any other type of sensor. In some arrangements, sensors 246 may be formed along with control circuit 242 as a single combined unit. Alternatively, in some arrangement sensors 246 and control circuit 242 may be communicatively connected by communication circuit 250

### User Interface 244:

User interface 244 is formed of any suitable size, shape, design, technology, and in any arrangement, and is configured to facilitate user control and/or adjustment of various components of system 100. In one or more arrangements, as one example, user interface 244 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input Optionally, in one or more arrangements, user interface 244 includes a display (not shown). Display is formed of any suitable size, shape, design, technology, and in any arrangement, and is configured to facilitate display information of settings, sensor readings, time elapsed, and/or other information pertaining to production of dessert products 10. In one or more arrangements, display may include, for example, LED lights, meters, gauges, screen or monitor of a computing device, tablet, and/or smartphone Additionally or alternatively, in one or more arrangements, the inputs and/or display may be implemented on a separate device that is communicatively connected to control circuit 242. For example, in one or more arrangements, operation of control circuit 242 may customized using a smartphone or other computing device that is communicatively connected to the control circuit 242 (e.g., via Bluetooth, WIFI, and/or the internet).

From the above discussion it will be appreciated that one or more arrangements presented herein improve upon the state of the art and provide a method and/or system for production of a dessert product having waffle cones with a filling. Specifically, one or more arrangements provide a wearable device, system, and/or method for formation of a dessert product having waffle cones with a filling: that is streamline; that can be implemented in a production line; that is easy to control; that is relatively inexpensive; that reduces byproduct waste; that is easy to use; that has a long useful life; that is durable; that has a robust design; and/or that is high quality among countless other advantages and improvements. These and countless other objects, features, or advantages of the present disclosure will become apparent from the specification, figures, and claims.

### SELECTED REFERENCE NUMBERS

10—Dessert
12—Waffle Cone (of Dessert 10)
14—Filling (of Dessert 10)
16—Pointed End (of Waffle Cone 12)
18—Open End (of Waffle Cone 12)
20—Non-Uniform Edge (of Waffle Cone 12)
22—Upper Portion (of Waffle Cone 12)
24—Uniform Edge (of Waffle Cone 12)
30—Waffle Batter
32—Waffles
60—Process Block (of FIG. 1)
62—Process Block (of FIG. 1)
64—Process Block (of FIG. 1)
66—Process Block (of FIG. 1)
68—Process Block (of FIG. 1)
80—Process Block (of FIG. 2)
82—Process Block (of FIG. 2)
84—Process Block (of FIG. 2)
86—Process Block (of FIG. 2)
88—Process Block (of FIG. 2)
90—Process Block (of FIG. 2)
92—Process Block (of FIG. 2)
100—System
104—Conveyor (of System 100)
110—Cone Dispenser (of System 100)
112—Cutting Apparatus (of System 100)
114—Filling Dispenser (of System 100)
120—Rollers (of Conveyor 104)
122—Belt (of Conveyor 104)
124—Holders (of Conveyor 104)
126—Segments (of Conveyor 104)
128—Motor (of Conveyor 104)
134—Tube Feeders (of Cone Dispenser 110)
136—Meter Assemblies (of Cone Dispenser 110)
138—Upper End (of Tube Feeders 134)
140—Lower End (of Tube Feeders 134)
142—Hollow Interior (of Tube Feeders 134)
148—Container (of Filling Dispenser 114)
150—Dispense Mechanism (of Filling Dispenser 114)
152—Nozzles (of Filling Dispenser 114)
156—Opening (of Nozzles 152)
160—Output Section
162—Conveyor (of Output Section 160)
164—Transporter (of Output Section 160)
174—Rollers
176—Belt
178—Motor
180—Channels (of Belt 176)
182—Walls (of Belt 176)
190—Waffle Cone Maker (of System 100)
192—Conveyor (of Waffle Cone Maker 190)
194—Batter Dispenser (of Waffle Cone Maker 190)
196—Waffle Iron (of Waffle Cone Maker 190)
198—Cone Roller (of Waffle Cone Maker 190)
202—Rollers
204—Belt
206—Motor
210—Container (of Batter Dispenser 194)
212—Dispense Mechanism (of Batter Dispenser 194)
214—Nozzles (of Batter Dispenser 194)
216—Opening (of Nozzles 214)
220—Cone Shaped Armatures (of Cone Roller 198)
222—Shafts (of Cone Roller 198)
224—Actuator Assembly (of Cone Roller 198)
240—Control System
242—Control Circuit
244—User Interface
246—Sensors
250—Communication Circuit
252—Processing Circuit
254—Memory
256—Code

1. A method of trimming a cone-shaped wafer, comprising:
providing an edible wafer that has a three-dimensional shape of a cone, wherein the cone has an initial length, and the cone has an open end that has an initial diameter; and
trimming the open end of the cone with an ultrasonic knife, wherein the trimming removes a portion of the edible wafer from the open end of the cone to produce a trimmed cone.

2. The method as claimed in claim 1, wherein the ultrasonic knife is operated at a frequency of at least 20 kilohertz and no greater than 100 kilohertz.

3. The method as claimed in claim 1, wherein the ultrasonic knife has a cutting blade that is metal or a metal alloy, and the cutting blade is configured according to a finite element model to cut food products.

4. The method as claimed in claim 1, wherein the trimmed cone has a trimmed length of no greater than 117 millimeters.

5. A method of trimming a cone-shaped wafer, comprising:
providing an edible wafer that has a three-dimensional shape of a cone, wherein the cone has an initial length, and the cone has an open end that has an initial diameter; and
trimming the open end of the cone, wherein the trimming removes a portion of the edible wafer from the open end of the cone to produce a trimmed cone, and the trimmed cone has a trimmed length of no greater than 117 millimeters.

6. The method as claimed in claim 5, wherein the trimming the performed with a reciprocating saw or a tube cutter.

7. The method as claimed in claim 1, wherein the edible wafer is an ice cream cone.

8. The method as claimed in claim 1, wherein the edible wafer comprises a flour.

9. The method as claimed in claim 1, wherein the trimmed cone has a trimmed open end that has a trimmed diameter of no greater than 51 millimeters.

10. The method as claimed in claim 9, wherein the trimmed diameter is at least 16 millimeters and no greater than 51 millimeters.

11. The method as claimed in claim 1, wherein the trimmed cone has a trimmed length of at least 41 millimeters and no greater than 117 millimeters.

12. The method as claimed in claim 1, wherein the edible wafer has a minimum thickness of no greater than 9 millimeters.

13. The method as claimed in claim 12, wherein the minimum thickness is at least 1 millimeter and no greater than 9 millimeters.

14. The method as claimed in claim 1, wherein the trimmed cone has a mass of at least 2 grams and no greater than 21 grams.

15. The method as claimed in claim 1, wherein the trimmed cone has a tensile strength of no greater than 40 newtons.

16. The method as claimed in claim 15, wherein the tensile strength is at least 3 newtons and no greater than 40 newtons.

17. The method as claimed in claim 1, further comprising:
dispensing a filling into the trimmed cone to produce an edible product; and
packaging the edible product in packaging, wherein the packaging comprises a nutrition label.

18. The method as claimed in claim 17, comprising:
providing a dispensing device that comprises a heat exchanger, wherein the dispensing is performed with the dispensing device;
heating the filling with the heat exchanger of the dispensing device; and
cooling the edible product,
wherein:
the filing has a melting point;
heating the filling comprises heating to a temperature that is greater than the melting point of the filling; and
cooling the edible product comprises cooling to a temperature below the melting point of the filling.

19. The method as claimed in claim 17, wherein the filling is a solid at 21 degrees Celsius.

20. A trimmed cone-shaped wafer prepared according to the method as claimed in claim 1.
